(19) United States
(12) Patent Application Publication
(10) Pub. No.: US 2016/0375392 A1
(43) Pub. Date: Dec. 29, 2016

(54) AIR CLEANER

(71) Applicant: ESTA Apparatebau GmbH & Co. KG, Senden (DE)

(72) Inventors: Michael Novosel, Heidenheim (DE); Bernhard Frank, Weissenhorn (DE)

(21) Appl. No.: 14/832,388

(22) Filed: Aug. 21, 2015

(30) Foreign Application Priority Data
Jun. 24, 2015 (DE) 10 2015 110 191.2

(51) Int. Cl. B01D 46/00

(52) U.S. Cl. CPC B01D 46/0005

(57) ABSTRACT

The invention pertains to an air cleaner (1) with a process chamber (2), in which at least one air filter unit (3) is arranged, wherein air is discharged from the process chamber (2) through the at least one air filter unit (3) via at least one process chamber opening (4) on the process chamber ceiling (5), wherein the air filter unit (3) is mounted in a guide (6) on the process chamber ceiling (5), wherein projections (7) on the air filter unit (3) engage behind at least one guide rail (8) and the air filter unit (3) thereby can be mounted on the process chamber ceiling (5) in a sealed fashion around the process chamber opening (4), and wherein the guide rail (8) can be lowered from the process chamber ceiling (5) toward one side such that the air filter unit (3) can be pivoted down from the process chamber ceiling (5) and extracted from the guide rail (8).

The invention pertains to an air cleaner with a process chamber, in which at least one air filter unit is arranged.

In industrial air cleaners, air filter units are arranged in the process chamber of such an air cleaner. In this case, the air filter units are relatively large and possibly contaminated with filtrate. Until now, such air filter units had to be elaborately detached from their mountings in the process chamber, wherein increased caution and complicated work steps were required due to potentially harmful or contaminating filtrate.

The invention is based on the objective of making available an improved air cleaner, in which an exchange of the air filter unit is simplified.

This objective is attained with an air cleaner according to the characteristics of claim 1.

The invention accordingly proposes an air cleaner with a process chamber, in which at least one air filter unit is arranged, wherein air is discharged from the process chamber through the at least one air filter unit via at least one process chamber opening on the process chamber ceiling, wherein the air filter unit is mounted in a guide on the process chamber ceiling, wherein projections on the air filter unit engage behind at least one guide rail and the air filter unit thereby can be mounted on the process chamber ceiling in a sealed fashion around the process chamber opening, and wherein the guide rail can be lowered from the process chamber ceiling toward one side such that the air filter unit can be pivoted down from the process chamber ceiling and extracted from the guide rail. A particularly effective exchange of the air filter unit therefore can be realized by simply extracting this air filter unit from the rail after it was lowered on one side. It may be advantageous to previously pull a film over the accessible part of the filter.

The air filter unit is preferably sealed relative to the process chamber on the process chamber ceiling by means of a seal around the process chamber opening. This embodiment is advantageous because the rail pulls the air filter unit against the process chamber ceiling when it is not lowered.

It is advantageously proposed that the guide rail is on one end hinged to the process chamber ceiling and can at least on its other end be lowered from the process chamber ceiling by means of a threaded tensioning element mounted on the process chamber ceiling.

According to an embodiment of the invention, the air filter unit may be realized in the form of at least one filter element that hangs from the process chamber ceiling. This filter element may, for example, also consist of a round filter.

The process chamber preferably can be opened by means of a hatch on the side of the guide rail, on which it can be lowered.

The invention is described in greater detail below with reference to the drawings. In these individual schematic drawings:

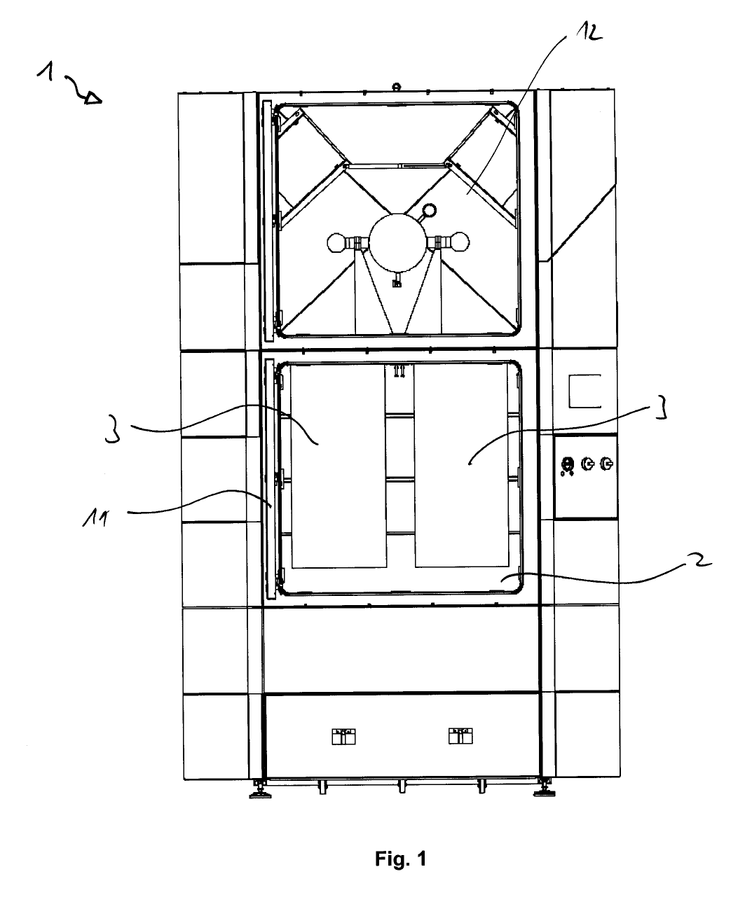

FIG. 1 shows a schematic representation of an inventive air cleaner with an opened hatch,

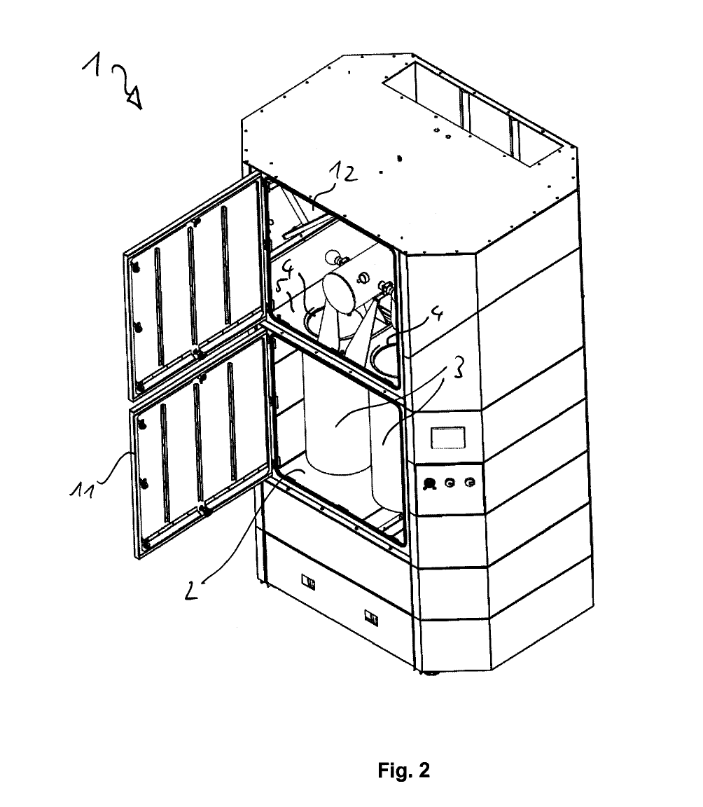

FIG. 2 shows the air cleaner according to FIG. 1 in the form of an oblique top view,

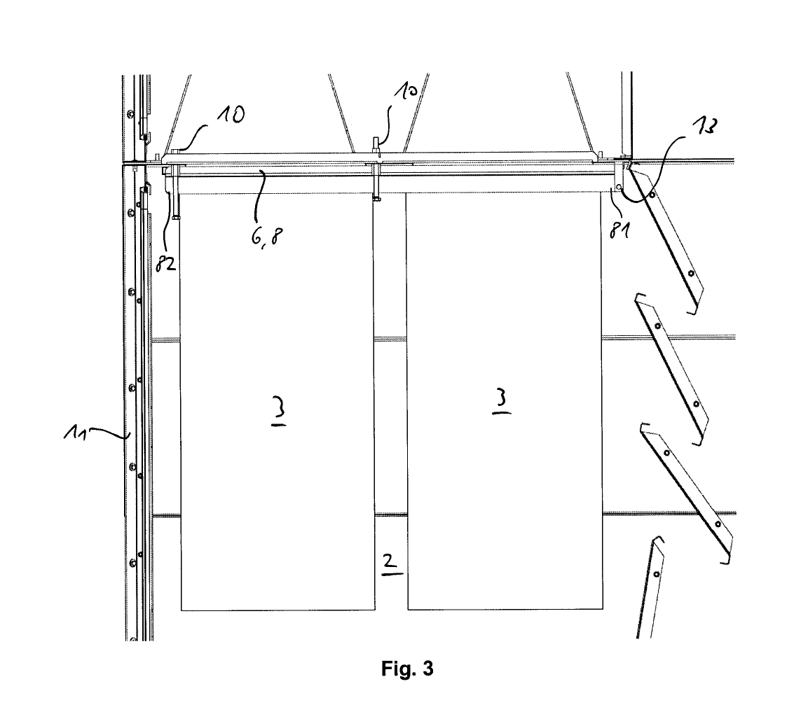

FIG. 3 shows a sectioned detail of the air filter units inserted into the air cleaner,

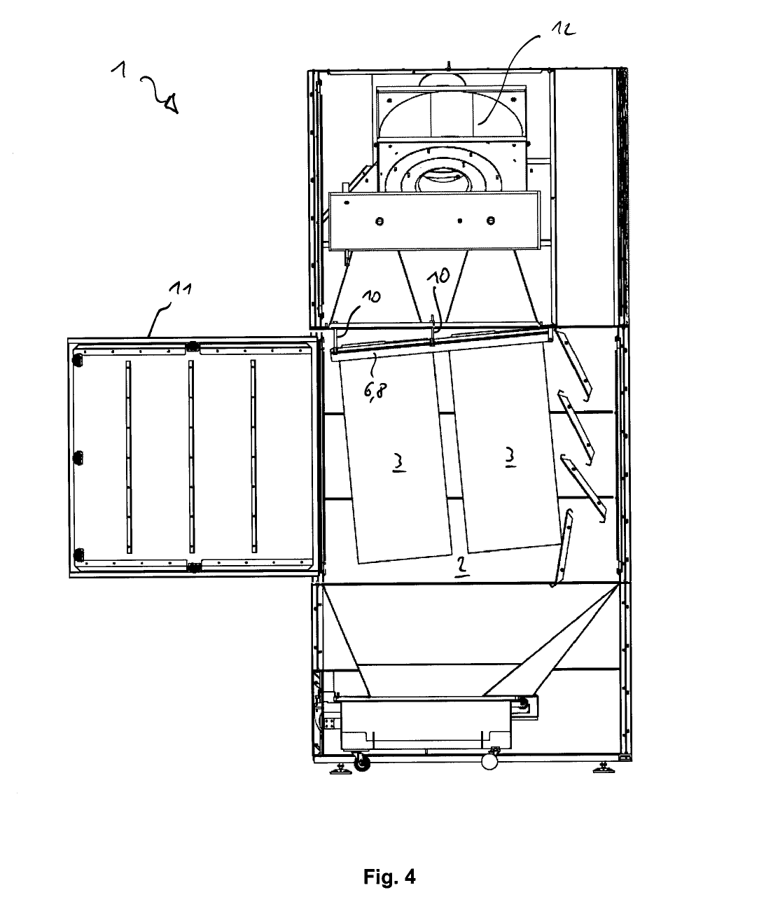

FIG. 4 shows a sectioned detail of the air cleaner with lowered guide rail,

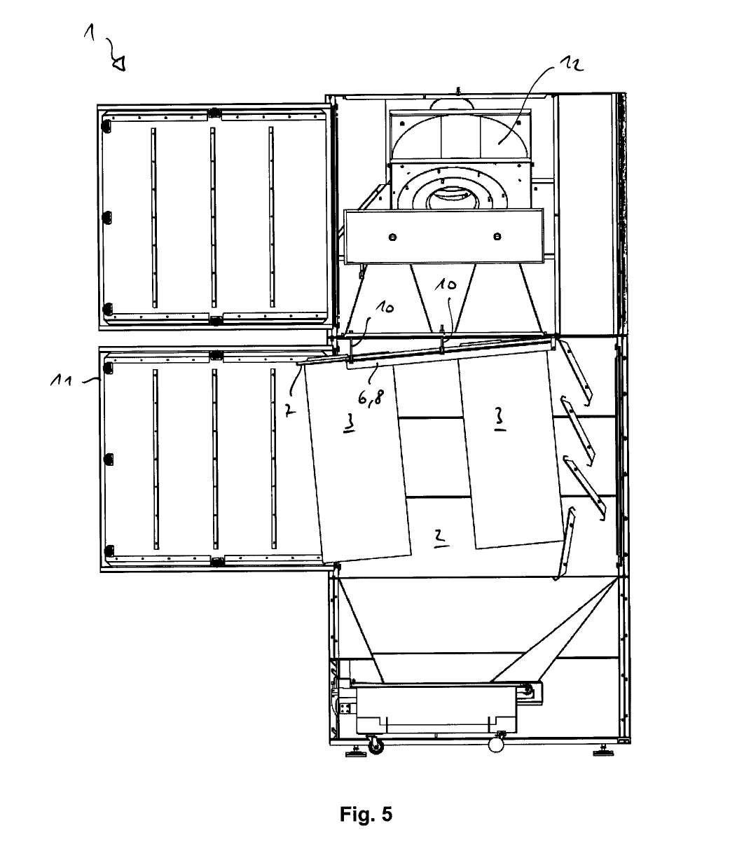

FIG. 5 shows a sectioned detail of the air cleaner with partially extracted air filter unit,

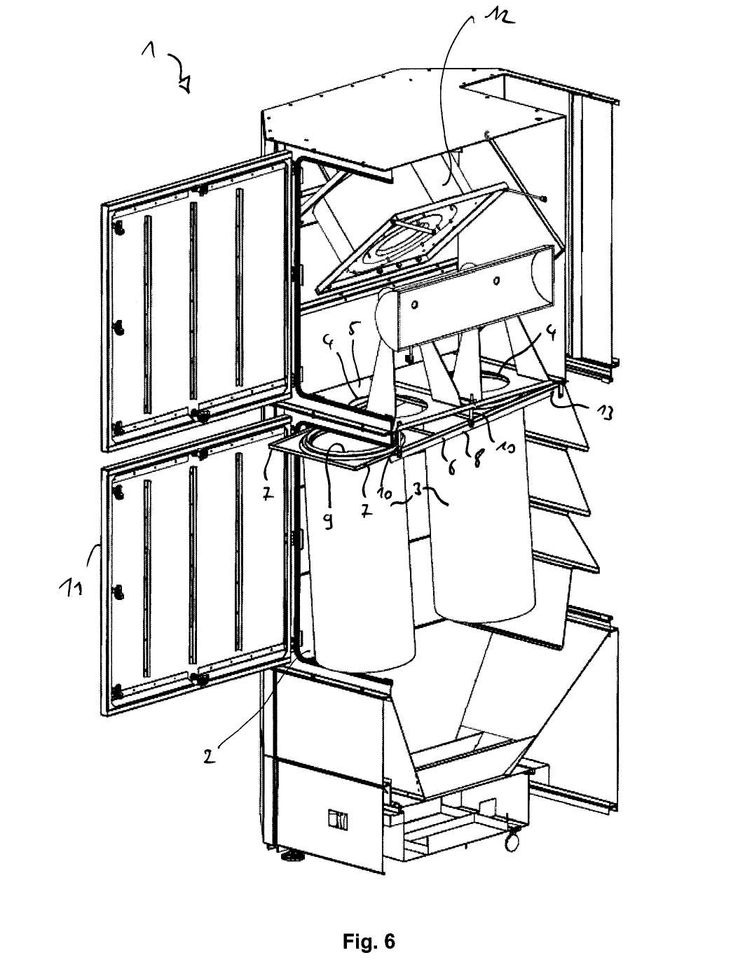

FIG. 6 shows a sectioned detail of the air cleaner with partially extracted air filter unit from a different viewing direction,

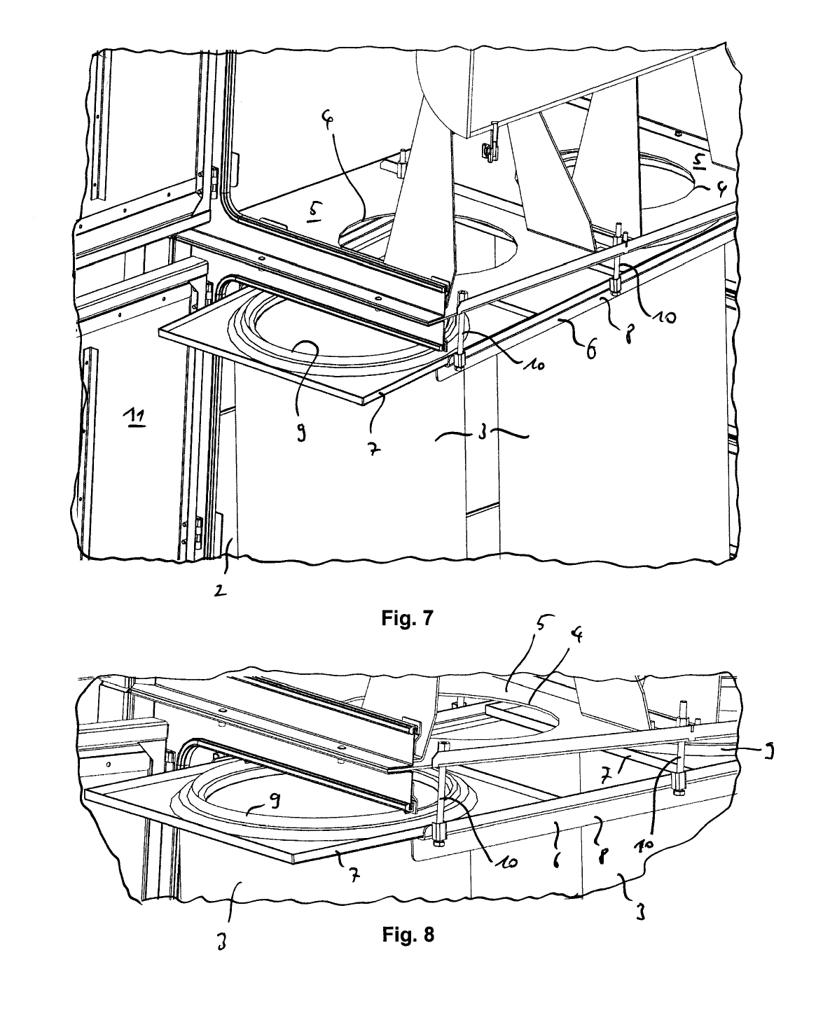

FIG. 7 shows a detail of the lowered guide rail and partially extracted air filter unit according to FIG. 6, and

FIG. 8 shows another detail of the lowered guide rail and partially extracted air filter unit according to FIG. 6 from a different viewing direction.

In these figures, identical or identically acting elements are identified by the same reference symbols.

FIG. 1 shows a schematic illustration of an inventive air cleaner 1 with an opened hatch 11 and a process chamber 2, in which several air filter units 3 are arranged such that they hang from the process chamber ceiling 5. This figure also shows the fan 12, by means of which the particle-laden air is withdrawn from the process chamber 2 through the air filter units 3.

FIG. 2 shows an oblique top view of the air cleaner 1, wherein the process chamber ceiling 5 defining the process chamber 2 and its process chamber openings 4 are visible in this view.

The sectioned detail according to FIG. 3 shows the inserted air filter units 3 mounted on the process chamber ceiling 5 by means of a guide 6.

For this purpose, the guide 6 features a guide rail 8 that is on one end 81 hinged 13 to the process chamber ceiling 5 and can on its other end 82 be lowered from the process chamber ceiling 5 by means of a threaded tensioning element 10 mounted on the process chamber ceiling 5.

This lowering of the guide rail by detaching the threaded tensioning element 10 is illustrated in greater detail in FIG. 4. The air filter units 3 are pivoted down from the process chamber ceiling 5 together with the guide rail 8 and therefore can be extracted from the guide rail 8 as illustrated in FIG. 5.

FIG. 6 shows the same situation as FIG. 5 in the form of a schematic sectional view. This figure once again shows the projections 7 on the air filter unit 3, which engage behind the guide rail 8. The air filter units 3 can be mounted on the process chamber ceiling 5 such that they are well sealed around the process chamber opening 4 by tightening the threaded tensioning element 10. The sealing effect relative to the process chamber 2 is in this case increased by means of a seal 9 that is pressed against the process chamber ceiling 5 around the process chamber opening 4.

FIGS. 7 and 8 show additional details of the guide rail 8—respectively provided to both sides of the air filter units 3—after it was lowered by means of the threaded tensioning elements 10, as well as the partially extracted air filter units 3, wherein these air filter units are realized in the form of round filters in the example shown.

### LIST OF REFERENCE SYMBOLS

1 Air cleaner
2 Process chamber
3 Air filter unit
4 Process chamber opening
5 Process chamber ceiling
6 Guide
7 Projection
8 Guide rail
9 Seal
10 Threaded tensioning element
11 Hatch
12 Fan
13 Hinge

1. An air cleaner with a process chamber, in which at least one air filter unit is arranged, wherein air is discharged from the process chamber through the at least one air filter unit via at least one process chamber opening on the process chamber ceiling (5), wherein the air filter unit is mounted in a guide on the process chamber ceiling, wherein projections on the air filter unit engage behind at least one guide rail and the air filter unit thereby can be mounted on the process chamber ceiling in a sealed fashion around the process chamber opening, and
wherein the guide rail can be lowered from the process chamber ceiling toward one side such that the air filter unit can be pivoted down from the process chamber ceiling and extracted from the guide rail.

2. The air cleaner according to claim 1, wherein
the air filter unit is sealed relative to the process chamber on the process chamber ceiling by means of a seal around the process chamber opening.

3. The air cleaner according to claim 1, wherein
the guide rail is on one end hinged to the process chamber ceiling and can at least on its other end be lowered from the process chamber ceiling by means of a threaded tensioning element mounted on the process chamber ceiling.

4. The air cleaner according to claim 1, wherein
the air filter unit is realized in the form of at least one filter element that hangs from the process chamber ceiling.

5. The air cleaner according to claim 1, wherein
the process chamber can be opened by means of a hatch on the side of the guide rail, on which it can be lowered.
